(19) United States
(12) Patent Application Publication
(10) Pub. No.: US 2016/0378251 A1
(43) Pub. Date: Dec. 29, 2016

(54) SELECTIVE POINTER OFFSET FOR TOUCH-SENSITIVE DISPLAY DEVICE

(71) Applicant: Microsoft Technology Licensing, LLC, Redmond, WA (US)

(72) Inventor: Brian Aznoe, Sherwood, OR (US)

(21) Appl. No.: 14/752,432

(22) Filed: Jun. 26, 2015

(51) Int. Cl. G06F 3/041; G06F 3/0488; G06F 3/0481

(52) U.S. Cl. CPC G06F 3/0418; G06F 3/0412; G06F 3/04812; G06F 3/04883

(57) ABSTRACT

A user contacts a touch-sensitive surface of a touch-sensitive display device with a finger. An initial finger contact patch is determined for the user finger, and a default position is assigned to a display pointer based on the initial finger contact patch. The display pointer is assigned to an offset position, different from the default position responsive to detecting a triggering gesture input from the user finger.

### BACKGROUND

Touch-sensitive display devices may allow a user to target and select objects displayed on the device. While a user's finger may be the most convenient means of interacting with a touch-sensitive display device, a finger may not be the most accurate or precise means of targeting display objects. A display pointer may thus be utilized to increase the quality of a user's interactive experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A user contacts a touch-sensitive surface of a touch-sensitive display device with a finger. An initial finger contact patch is determined for the user finger, and a default position is assigned to a display pointer based on the initial finger contact patch. The display pointer is assigned to an offset position, different from the default position responsive to detecting a triggering gesture input from the user finger.

### BRIEF DESCRIPTION OF THE DRAWINGS

FIG. 1A shows an example touch-sensitive display device.

FIG. 1B shows a magnified view of the touch-sensitive display device of FIG. 1A including example finger contact patches.

FIGS. 1C and 1D show examples of fingers contacting a touch-sensitive surface at different approach angles.

FIG. 2 depicts an example touch-sensor matrix that may form part of the touch-sensitive display device of FIG. 1A.

FIG. 3 shows a method for selectively offsetting a display pointer from a finger contact patch on a touch-sensitive surface.

FIG. 4 shows a timeline for an example triggering gesture that may be used to selectively offset a display pointer.

FIG. 5A shows a magnified view of a touch-sensitive display device including a display pointer at an offset position.

FIGS. 5B and 5C show timelines for example modifying commands that may be used to selectively adjust the offset position of a display pointer.

FIG. 6 schematically shows a sensory-and-logic system usable to selectively offset a pointer from a finger contact patch on a touch-sensitive display device.

### DETAILED DESCRIPTION

When operating a small touch-sensitive display device, often times the user is unable to precisely target points or objects on appearing on the display. In some scenarios, the finger is significantly larger than the desired target and/or the finger has a large contact area relative to the size of the desired target. In these scenarios, the user's intent may not align with the output of the algorithms used to determine object targeting on the display screen. As a result, the user may select a display object other than the desired target, thus causing frustration with the software and/or hardware. For example, an “X” denoting a target for closing a pop-up advertisement may have an area less than 1/10th the area of the user's finger contact patch, leading to the user selecting the advertisement when attempting to select the closing target. Aside from user frustration, this may also result in additional data usage.

For touch-sensitive display devices that are relatively small compared to the finger of a user, targeted display icons may be visually occluded by a finger contact patch, finger, and hand of the user. Further, as the contact patch area may extend across multiple display icons, a decision may be made at the software level to select a subset of the contact patch area to act as a pointer or cursor. For example, a centroid of the contact patch area may be chosen by default as the pointer. As the user's finger obscures a pointer within the contact patch area, there may be a disconnect between the user's intent and expectations regarding pointer position and targeting as opposed to what is actually being sensed and determined. Although larger format touch-sensitive display devices are less prone to these problems, thicker cover glass is often needed to protect the display device, yielding an increased parallax between the user's finger and the targeted display icon.

Some touch-sensitive display devices include a stylus, but this adds to manufacturing costs and can be easily misplaced. Other devices allow a “hover” feature, but this is not easy to consistently activate, as holding a finger a fixed distance from a screen without touching the surface of the screen can be difficult for some users.

According to the present disclosure, a display pointer may be selectively offset from a finger contact patch responsive to a user providing a triggering gesture input. An initial finger contact patch may be determined for a user finger contacting a touch-sensitive surface of the touch-sensitive display device. A secondary finger contact patch may be determined for the user finger upon completion of the triggering gesture input. As such, detecting a triggering gesture input may be based on a comparison of one or more properties of the initial finger contact patch to one or more properties of the secondary finger contact patch.

The initial finger contact patch may determine a default position for a display pointer. Upon detecting an initial phase of the triggering gesture, the display pointer may emerge from the current finger contact patch. When the triggering gesture is completed, the display pointer may be locked into an offset position based on a secondary finger contact patch and presented at a distance from subsequent finger contact patches while maintaining normal touch contact and manipulation, thus allowing for display objects to be targeted and selected without being the display objects or the display pointer being occluded from the view of the user. In one example, the triggering gesture may comprise a user rolling a finger from a shallow approach angle to a steep approach angle.

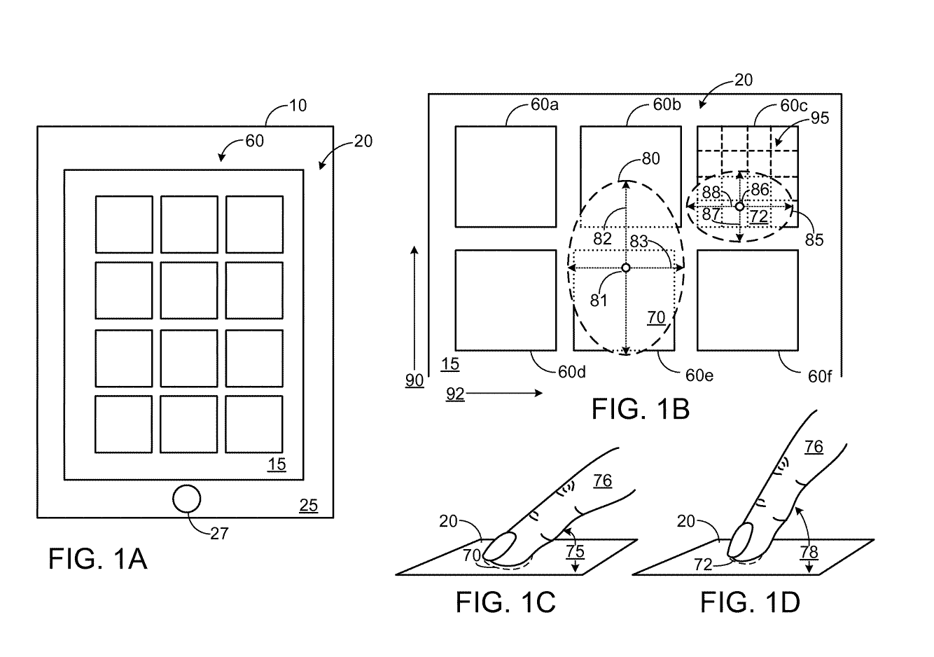

FIG. 1A shows an example touch-sensitive display device 10 in accordance with an embodiment of the present disclosure. Touch-sensitive display device 10 includes a display system 15, and a touch-sensitive surface 20. In some examples, touch-sensitive surface 20 is coincident with display system 15. In other examples, touch-sensitive surface 20 may only be overlaid on select portions or regions of display system 15. In still other examples, touch-sensitive surface 20 may extend outside the boundaries of display system 15 and into border region 25. Touch-sensitive display device 10 may further includes user-input button 27.

Touch-sensitive surface 20 may be configured to sense multiple sources of touch input, such as touch input applied by a digit of a user or a stylus manipulated by the user. Touch-sensitive surface 20 may be a capacitive touch-sensitive surface configured to sense one or more sources of touch input concurrently. Touch-sensitive surface 20 may be equipped with one or more matrixes of electrodes comprising capacitive elements positioned a distance the external surface of touch-sensitive display device 10. A touch-sensing matrix may be arranged planarly relative to display system 15. Typically, this involves the touch-sensing matrix being arranged over, or at some depth within, the display system. Further, the touch-sensing matrix typically will be parallel (or nearly so) to display system 15, though other orientations are possible.

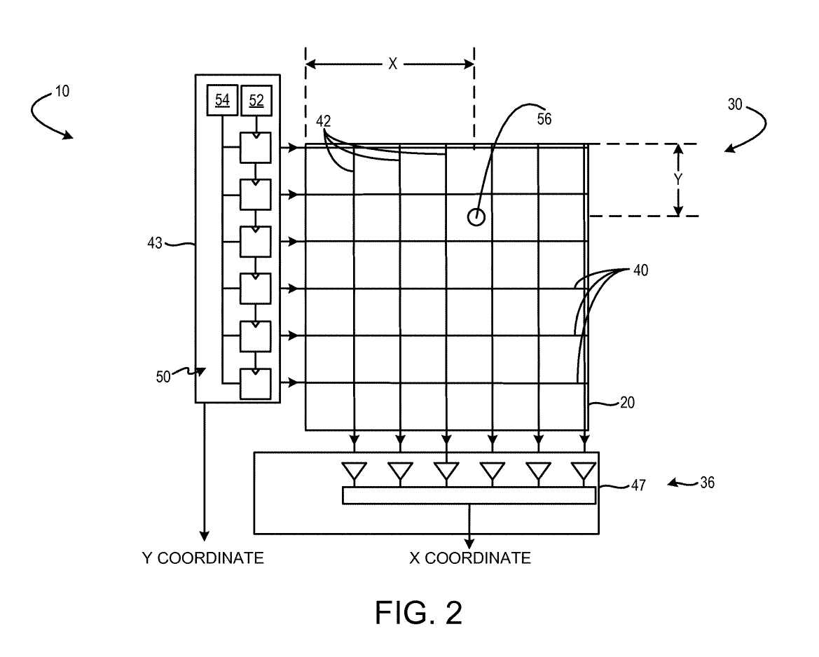

FIG. 2 shows additional aspects of a touch-sensing matrix 30 included in the touch-sensitive display device 10. It should be understood that other types of touch-sensing matrixes or other touch-sensing apparati may be included in touch-sensitive display device 10 in addition to or as an alternative to touch-sensing matrix 30. Arranged on touch-sensitive surface 20 is a series of rows 40 (e.g., row electrodes) and a series of columns 42 (e.g., column electrodes). Touch-sensitive surfaces contemplated herein may include any number N of rows 40 and any number M of column 42. Further, although it is customary to have the rows 40 aligned horizontally and the columns 42 aligned vertically, this aspect is in no way necessary: indeed, the terms ‘row’ and ‘column’ may be exchanged everywhere in this description. For example, the term row and column does not denote a global orientation but rather denotes the orientation of the electrodes with respect to one another. The rows 40 in touch-sensing matrix 30 may be sequentially electrically excited and the columns 42 in touch-sensing matrix 30 are scanned to pick up an incoming signal for downstream correlation operations. In some examples, the rows 40 may be excited using unique electrical signals for each row, for example signals comprising varied frequencies and/or amplitudes row.

A drive subsystem 43 and matrix receive circuitry 47 are also shown in FIG. 2. Matrix receive circuitry 47 may include M column amplifiers, each coupled to a corresponding column 42. The drive subsystem 43 may include a row counter 50 in the form of an N-bit shift register with outputs driving each of N rows 40. The row counter may be clocked by row-driver clock 52. The row counter can include a blanking input to temporarily force all output values to zero, independent of the values stored. Excitation of one or many rows may be provided by filling the row counter with ones at every output to be excited, and zeroes elsewhere, and then toggling the blanking signal with the desired modulation from modulation clock 54. In the illustrated embodiment, the output voltage may take on only two values, corresponding to the one or zero held in each bit of the row counter; in other embodiments, the output voltage may take on a greater range of values, to reduce the harmonic content of the output waveforms, or to decrease radiated emissions, for example.

The description above of row counter 50 should not be construed as limiting in any way, for numerous alternative implementations are equally contemplated. For instance, the row counter may be implemented as a micro-coded state machine within a field-programmable gated array (FPGA) with the touch-sensing logic described herein. In other embodiments, the row counter may be embodied as a register within a microprocessor, or as a data structure held in computer memory associated with the microprocessor. In these and other embodiments, the row counter may take on non-negative integer values—e.g., 0, 1, . . . N.

In the depicted example, drive subsystem 33 applies a drive signal to each row 40 in sequence. During a period in which touch-sensitive surface 20 is untouched, none of the column amplifiers registers an above-threshold output. However, when the user places a fingertip on the sensory surface, the fingertip capacitively couples one or more rows 40 intersecting finger contact patch 56 to one or more columns 42 also intersecting the touch point. The capacitive coupling induces an above-threshold signal from the column amplifiers associated with the column electrodes beneath (i.e., adjacent) the finger contact patch, which provides sensing of the finger contact patch. The matrix receive circuitry 47 returns, as the boundaries of the finger contact patch in the X direction, the numeric value of the columns providing the greatest signal. The matrix receive circuitry 47 also determines which rows were being excited when the greatest signal was received, and returns the numeric value of those rows as the boundaries of the finger contact patch in the Y direction. In one embodiment, matrix receive circuitry 47 may be implemented as a micro-coded state machine. However, numerous types of receive circuitry have been contemplated.

In the above description, finger contact patches are identified when given column signals go “above threshold.” Typically this determination is made in the context of a correlation operation. In many implementations, there is a design-time determination made as to the exact character (amplitude, frequency, etc.) of a signal that will be received into the column receive circuitry in the event of a touch, and in the event of no touch. In addition, predictions may be made about the likely noise that will also be received into the column receive circuitry at runtime (e.g., noise from power supply operation, operation of the display device, etc.).

The receive circuitry can thus run a correlation operation on that inbound signal, which essentially assesses the degree to which the inbound signal resembles what would be expected in the event of a finger touch. The correlation operation is “tuned” to account for the drive signal being used to excite the rows, in the sense that it typically uses a reference signal for the correlation that is based upon that drive signal. When the resemblance exceeds a threshold, the system affirmatively registers a touch occurring on that column. And as indicated above, the time at which it is received indicates the Y coordinate of the touch. A contact patch may be detected based on neighboring rows and columns indicating a touch simultaneously.

Returning to FIG. 1A, display system 15 is shown displaying a plurality of interactive display icons 60. Responsive to user input in the form of a touch on touch-sensitive surface 20, a display icon 60 may be selected thus providing a command to touch-sensitive display device 10 based on the properties of the selected interactive display icon 60. Display system 15 may be connected to an image source, such as an external computer or onboard processor. The image source may produce appropriate graphical output in response to touch input detected at touch-sensitive surface 20.

FIG. 1B depicts a magnified view of display system 15 and touch-sensitive surface 20, including interactive display icons 60a-60f. A first example contact patch 70 and a second example contact patch 72 are shown overlaid on display system 15. First example contact patch 70 is representative of a contact patch resulting from a first approach angle 75 between a user's finger 76 and touch-sensitive surface 20, as shown in FIG. 1C, while second example contact patch 72 is representative of a second, steeper approach angle 78 between user's finger 76 and touch-sensitive surface 20, as shown in FIG. 1D.

First example contact patch 70 includes boundary 80, which may approximate the contact area between user's finger 76 and touch-sensitive surface 20. A centroid 81 may be determined for first example contact patch 70, which may represent the center of mass of first example contact patch 70. In this example, first example contact patch 70 is depicted as an ellipsoid area, and thus centroid 81 is located at the intersection of first axis 82 and second axis 83. Similarly, second example contact patch 72 includes boundary 85, centroid 86, first axis 87 and second axis 88.

First axis 82 and first axis 87 extend in a lengthwise direction 90 along touch-sensitive surface 20, while second axis 83 and second axis 88 extends in a crosswise direction 92 along touch-sensitive surface 20. Due to the difference between first approach angle 75 and second approach angle 78, boundary 80 comprises a larger area than does boundary 85. Further, while first axis 82 and second axis 83 represent the long and short axes of first example contact patch 70, respectively, first axis 87 and second axis 88 represent the short and long axes of second contact patch 72, respectively.

In a scenario wherein a contact patch centroid is selected as the center of a display pointer (e.g., a cursor, arrow, or other icon that is visually presented on the display device akin to systems using a mouse, trackpad, trackball, etc.), the display pointer is thus obscured from the view of the user by the contact patch, as are display icons (or regions of display icons) situated below the contact patch. As shown in FIG. 1B, centroid 81 is located within the boundaries of display icon 60e, which is almost completely obscured by first example contact patch 70. Concurrently, display icon 60b is partially obscured by first example contact patch 70, while an upper intersection between boundary 80 and first axis 82 approaches the center of display icon 60b. A user intending to select display icon 60b via first example contact patch 70 may have selected display icon 60e instead.

In some examples, this problem may be partially addressed by selecting the upper intersection between the boundary and first axis as the center of the display pointer. However, this display pointer location remains obscured from the view of the user. Further, the contact patch continues to obscure display icons.

A user may opt to select a steep approach angle between user's finger 76 and touch-sensitive surface 20, such as approach angle 78, in order to reduce the area of the contact patch as well as to increase visibility of the underlying display. However, this approach may be insufficient to provide a desired amount of accuracy and/or precision in selecting display icons. For example, display icon 60c is shown subdivided into a plurality of sub-icons 95. Each sub-icon 95 may be associated with a different command and expected response. Second example contact patch 72, while providing a smaller area and less visual obfuscation than for first example contact patch 70, still obscures numerous sub-icons 95, preventing the user from confidently selecting a desired sub-icon, regardless of the location of the pointer within second example contact patch 72.

As such, it may be beneficial to provide a touch-sensitive display device user with a means for increasing targeting accuracy and precision on-demand, while still enabling normal finger-to-surface contact and manipulation, and allowing the user to selectively return to a “classic” interaction mode when desired.

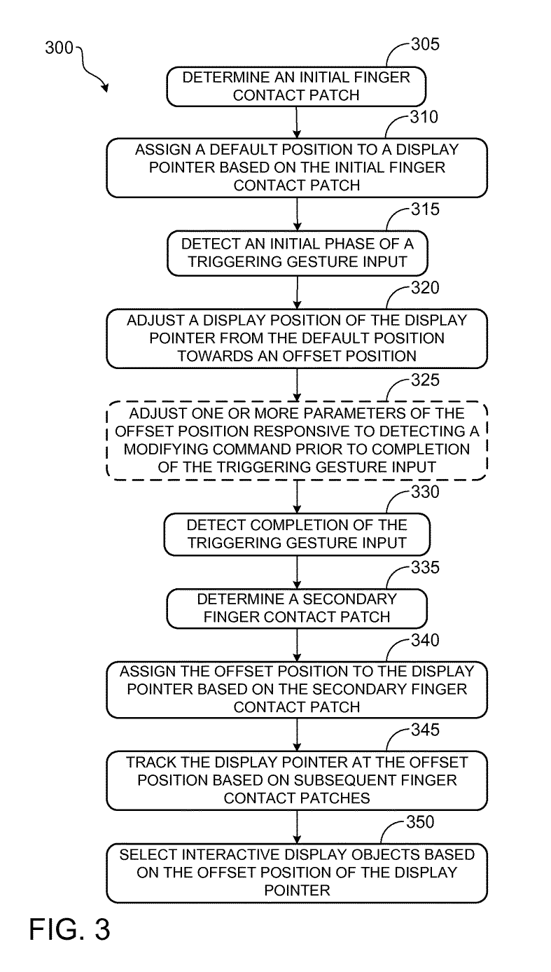

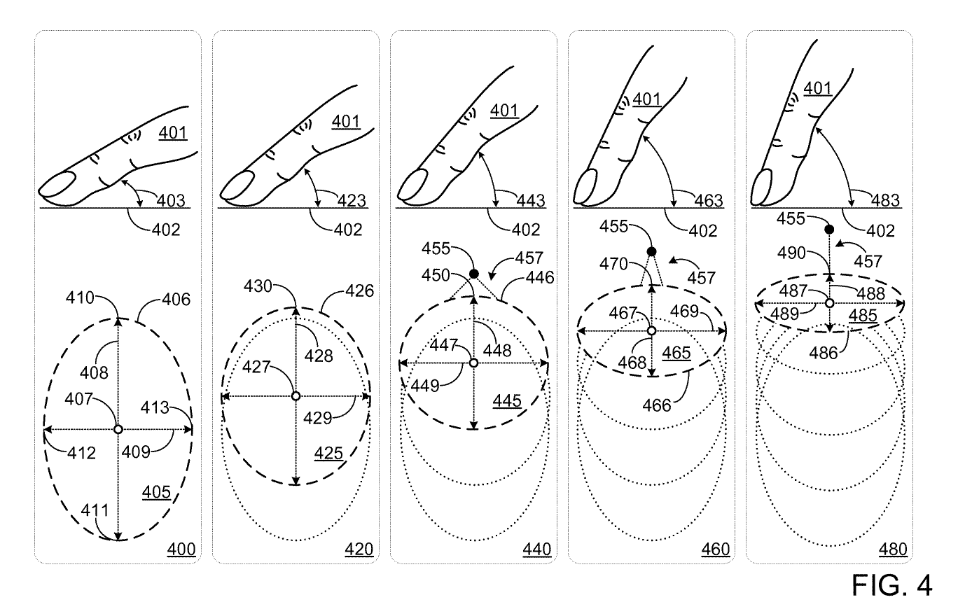

FIG. 3 presents an example method 300 for selectively offsetting a display pointer from a user's finger contact patch responsive to a triggering gesture. Method 300 may be used in conjunction with a touch-sensitive display device, such as touch-sensitive display device 10. FIG. 4 schematically shows an example triggering gesture, where a user rolls a finger on a touch-sensitive surface from a flattened conformation to a fingertip. However, a plurality of triggering gestures may be used without departing from the scope of this disclosure. Gestures may be customized and programmed by a user to their specification, including for individual users of common touch-sensitive display devices. The triggering gesture may comprise at least an initial phase and a secondary phase, the combination of which may be distinguishable from other gesture commands assigned specific tasks on the touch-sensitive display device.

Turning to FIG. 3, at 305, method 300 includes determining an initial finger contact patch. As described with reference to FIG. 2, one or more touch-sensing matrixes may detect contact between a user's finger and a touch-sensitive surface and determine properties of the finger contact patch. As described with reference to FIG. 1B, properties of the finger contact patch may include boundaries, a centroid, a first axis, a second axis, and intersections between the axes and the boundaries and/or centroid. In some examples, a pressure between the user's finger and the touch-sensitive surface may be determined.

Turning to FIG. 4, panel 400 shows a finger 401 contacting a touch-sensitive surface 402 at a first approach angle 403. For example, finger 401 may be placed with a fingertip flat on touch-sensitive surface 402 in a manner akin to providing a fingerprint. In this conformation, an initial contact patch 405 may be determined having a significantly elliptical shape. Properties of initial contact patch 405 include boundary 406, which may approximate the contact area between finger 401 and touch-sensitive surface 402. Further properties of initial contact patch 405 include centroid 407, first (long) axis 408, and second (short) axis 409. First axis 408 intersects with boundary 406 at upper intersection 410 (upper boundary) and lower intersection 411 (lower boundary), while second axis 409 intersects with boundary 406 at left intersection 412 (left boundary) and right intersection 413 (right boundary).

Returning to FIG. 3, at 310, method 300 includes assigning a default position to a display pointer based on the initial finger contact patch. For example, a default position may be assigned to the display pointer within boundary 406 of initial contact patch 405. In some examples, the default position may be at a centroid of the initial contact patch, such as centroid 407. In other examples, the default position may be at an upper intersection of the initial contact patch, such as upper intersection 410.

At 315, method 300 includes detecting an initial phase of a triggering gesture input. A triggering gesture input may be specified by the touch-sensitive display device, or may be selected and customized for a user. In this example a “triggering gesture input” comprises a repeatable movement that can be made by a digit (finger) of a user on the touch-sensitive surface of the touch-sensitive display device that is not assigned to another task. For example, the user may roll a finger forward, on the touch-sensitive surface, may move the finger in a pattern on the touch-sensitive surface (e.g., a check mark, a circle, triangle, or other shape, rapid movement back and forth or up and down, writing a letter or word, tapping in a single or multiple locations, etc.).

Depending on the triggering gesture, the initial phase may represent a portion of the triggering gesture that can be reasonably distinguished from other, similar gestures. For example, if the triggering gesture is a check-mark motion, the initial phase may comprise a downward motion followed by an initial angled upwards motion. When the initial angled upwards motion is detected, the check-mark motion can be reasonably identified as one of a limited number of potential gesture inputs.

The initial phase of the triggering gesture input may be detected based on a comparison of one or more properties of the initial finger contact patch to one or more properties of one or more subsequent finger contact patches. For example, the position of a centroid of the initial finger contact patch may be compared to positions of centroids of the one or more subsequent finger contact patches over time.

The initial phase may be detected based on a speed, distance and/or direction of movement of the centroid of sequential finger contact patches. Additionally or alternatively, the initial phase may be detected based on changes in boundary shape between the initial finger contact patch and subsequent finger contact patches, location of the centroid of a current finger contact patch relative to the boundary of the initial finger contact patch and/or relative to the boundary of the current finger contact patch, a change in contact pressure, an elapsed time spent at the initial and/or one or more subsequent finger contact patches, a position of the initial and/or subsequent finger contact patches relative to one or more features of the touch-sensitive surface and/or display screen, etc.

With reference to FIG. 4, panel 420 shows finger 401 contacting touch-sensitive surface 402 at second approach angle 423, steeper than first approach angle 403, as finger 401 begins a rolling motion. This conformation yields subsequent finger contact patch 425 (also referred to herein as intermediate finger contact patch 425. Properties of subsequent contact patch 425 include boundary 426, centroid 427, first axis 428, second axis 429, and upper intersection 430 (the lower, left and right intersections are not labeled). Next, panel 440 shows finger 401 contacting touch-sensitive surface 402 at third approach angle 443, steeper than second approach angle 423, as finger 401 continues the rolling motion. This conformation yields subsequent (intermediate) finger contact patch 445. Properties of subsequent finger contact patch 445 include boundary 446, centroid 447, first axis 448, second axis 449, and upper intersection 450.

Based on the properties of initial finger contact patch 405 and subsequent finger contact patches 425 and 445, an initial phase of the rolling motion may be detected. In this example, finger 401 maintains contact with touch-sensitive surface 402 throughout the initial phase of the rolling motion. Centroids 427 and 447 are thus maintained along their respective first axes, while progressing further away from centroid 407 and lower intersection 411. Similarly, upper intersections 430 and 450 also progress further away from centroid 407 (and lower intersection 411) as finger 401 rolls forward. In this example, boundaries 426 and 446 have progressively decreasing areas compared with boundary 406. In particular, first axes 428 and 448 are progressively shorter than first axis 408, while second axes 429 and 449 remain relatively equal in length to second axis 409. However, other embodiments of a rolling motion may maintain the areas of the finger patch boundaries.

In some examples, the initial phase of the rolling motion may only be detected if initial finger contact patch 405 is maintained for a threshold duration prior to rolling of the finger. Further, the initial phase of the rolling motion may be detected responsive to a speed in which centroids of subsequent finger contact patches move away from centroid 407, once the centroid of a subsequent finger contact patch is a threshold distance from centroid 407 along a first axis, once a boundary of a subsequent finger contact patch comprises an area that is a threshold smaller than the area of boundary 406, and/or when an upper intersection of a subsequent finger contact patch is a threshold distance from upper intersection 410. For example, the initial phase of the rolling motion is not detected at 420, but is detected at 440. If finger 401 returned to approach angle 403 after reaching approach angle 423, the initial phase of the rolling motion would not be detected.

Returning to FIG. 3, at 320, method 300 includes adjusting a display position of the display pointer from the default position towards an offset position. For example, a display pointer previously located at a centroid of a finger contact patch may emerge from the finger contact patch so that it is no longer obscured by the current finger contact patch. In some examples, movement of the display pointer may be based on the speed and/or direction of motion of sequential finger contact patch centroids and/or upper boundaries. For example the display pointer may move at twice the speed of motion of sequential finger contact patch centroids. As shown at panel 440 in FIG. 4, display pointer 455 has emerged from intermediate finger contact patch 445. In some examples, the emergence of display pointer 455 and progression towards an offset position may be indicated by animation on the display screen. For example, indicator lines 457 may show progression of display pointer 455 by moving closer together as display pointer 455 moves further away from the current finger contact patch, as shown in panel 460. In this way, the user is provided visual feedback that the initial phase of the triggering gesture has been detected, and that the display pointer is progressing towards the offset position. In other examples, concentric circles may merge towards an offset position, or the shape, color, size, or other properties of the display pointer may be adjusted over the progression of the triggering gesture once the initial phase has been detected.

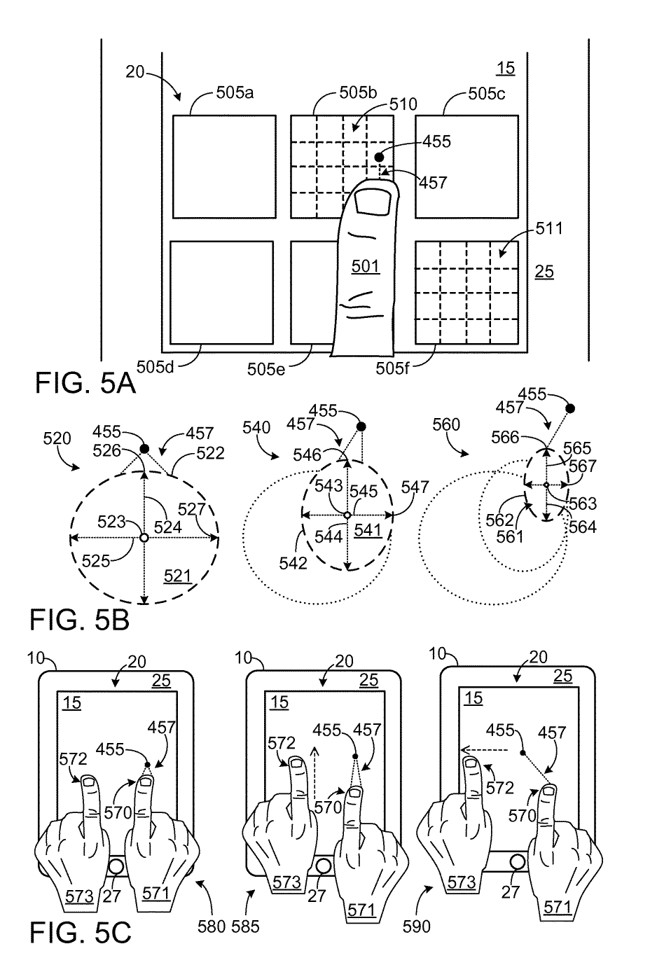

Returning to FIG. 3, at 325, method 300 may optionally include adjusting one or more parameters of the offset position responsive to detecting a modifying command prior to completion of the triggering gesture input. For example, rather than progressing through the secondary phase of the triggering gesture input, a user may issue a modifying command in the form of touch input, interaction with an additional user input device (e.g., user-input button 27), audible command, etc. The modifying command may enable a parameter of the offset position of the display pointer to be adjusted, such as the distance between the display pointer and a finger contact patch and/or an orientation of the display pointer relative to a finger contact patch, and/or may enable a parameter of the display pointer itself to be adjusted, such as a display area (size) of the display pointer, display appearance of the display pointer (e.g., color, translucency), etc. Upon completion of the modifying command and adjustment of one or more offset position and/or display pointer parameters, the adjusted offset position may be locked to a finger contact patch (in which case, method 300 may advance to 345), or the triggering gesture may be completed to lock the adjusted offset position (in which case, method 300 may proceed to 330). Example modifying commands and adjusted offset parameters are described in more detail with reference to FIGS. 5A-5D.

Returning to FIG. 3, at 330, method 300 includes detecting completion of the triggering gesture input. Completion of the triggering gesture input may be detected based on a detection of the secondary phase of the triggering gesture input, following the detection of the initial phase of the triggering gesture input. Similarly to detecting the initial phase of the triggering gesture input, detecting completion of the triggering gesture input and/or detecting the secondary phase of the triggering gesture input may be based on a comparison of one or more properties of the initial finger contact patch or an intermediate finger contact patch to one or more properties of one or more subsequent finger contact patches. For example, the completion of the triggering gesture may be detected based on the position, speed, distance and/or direction of movement of the centroid of sequential finger contact patches changes in boundary shape, location of the centroid of a current finger contact patch relative to the boundary of the initial finger contact patch, an intermediate finger contact patch, and/or relative to the boundary of the current finger contact patch, a change in contact pressure, an elapsed time spent at one or more intermediate finger contact patches, etc. If the progression of intermediate finger contact patches and/or their respective properties deviates from what is anticipated for the secondary phase of the triggering gesture (e.g., removal of the finger from the touch-sensitive surface, movement of the finger in a direction significantly different than the triggering gesture), method 300 may be aborted, and the display pointer returned to the default position upon (re-)engagement of the user's finger with the display surface.

In the example of FIG. 4, the rolling motion established in panels 420 and 440 is continued in panel 460. Panel 460 shows finger 401 contacting touch-sensitive surface 402 at fourth approach angle 463, steeper than third approach angle 443, as finger 401 continues the rolling motion. This conformation yields intermediate finger contact patch 465. Properties of intermediate finger contact patch 465 include boundary 466, centroid 467, first axis 468, second axis 469, and upper intersection 470. In accordance with continuing the rolling motion, finger 401 maintains contact with touch-sensitive surface 402, boundary 466 has a decreased area compared with boundary 446, first axis 468 is shorter than first axis 448, while second axis 469 is relatively equal in length to second axis 449. Centroid 467 is maintained along a straight line with centroids 407, 427, and 447, while both centroid 467 and upper intersection 470 progress further away from centroid 407 and lower intersection 411.

Alternatively, the triggering gesture may be aborted by moving finger 401 away from the coincident first axes (e.g. in a different direction) if a centroid of an intermediate finger contact patch is moved towards the lower intersection relative to a previous finger contact patch, and/or if the centroid of consecutive intermediate finger contact patches move perpendicular to the long axis of the initial finger contact patch. In this way, the rolling gesture may be distinguished from a typical scrolling gesture, wherein an upper boundary of a finger contact patch may pass through the centroid of a previous finger contact patch. In some examples, scrolling may be prevented or suspended while the display pointer is emerging, in order to prevent confusion on the part of the user.

The completion of the triggering gesture input may be detected when on one or more properties of a current finger contact patch exceeds a threshold difference relative to the initial or one or more intermediate finger contact patches. For example, panel 460 shows finger 401 contacting touch-sensitive surface 402 at fifth approach angle 483, steeper than fourth approach angle 463, as finger 401 yielding secondary finger contact patch 485, including boundary 486 and centroid 487. Centroid 487 is located outside of boundary 406. This conformation represents a completion of the rolling motion.

Returning to FIG. 3, at 335, method 300 includes determining a secondary finger contact patch. In some examples, the recognition of the secondary finger contact patch may precede or coincide with recognition of the triggering gesture input. With regard to panel 480 of FIG. 4, properties of secondary finger contact patch 485 may be determined, including boundary 486, centroid 487, first axis 488, second axis 489, and upper intersection 490.

Returning to FIG. 3, at 340, method 300 includes assigning the offset position to the display pointer based on the secondary finger contact patch. As shown in panel 480 of FIG. 4, display pointer 455 is located outside boundary 486 at a predetermined orientation, and at a predetermined distance from centroid 487. The predetermined distance may thus be a sufficient distance from the boundary of the secondary finger contact patch to enable visualization by the user without obstruction by a projection of the user's finger.

The predetermined distance may be set based on display system size and/or resolution, and may vary based on application and/or user preferences. Similarly, the predetermined orientation may vary for different scenarios. For example, the orientation may be adjusted or customized for left hand use and right hand use, based on the finger performing the triggering gesture, based on a dominant eye of a user, based on an angle or distance between the display system and the eyes of the user, etc.

Returning to FIG. 3, at 345, method 300 includes tracking the display pointer at the offset position based on subsequent finger contact patches. In order to maintain the increased precision enabled by the offset display pointer, the position of the pointer may be locked relative to one or more properties of the final finger contact patch, for example, at a distance and orientation relative to the centroid of the final contact patch. The display pointer may track with the user's finger at the offset position while the user's finger remains in contact with the touch-sensitive surface, allowing the user to accurately position the display pointer over a desired target on the display screen. The offset position may be maintained outside boundaries of subsequent finger contact patches, allowing for visualization of the display pointer.

In some embodiments, the user may adjust a position and/or orientation of the display pointer once the display pointer has been locked to the offset position. Adjusting the offset position of the display pointer may be accomplished as described at 325 (and described in further detail with reference to FIGS. 5A-5D, although a separate modifying command may be used in embodiments where adjustment of the offset position was enabled prior to locking the offset position.

In some examples the display pointer may be maintained at the offset position regardless of whether the properties of the final finger contact patch are maintained through subsequent finger contact patches. In other examples, the offset position may be aborted if the current finger contact patch is significantly changed from the final finger contact patch. In some examples, the display pointer may be returned to the default position by user moving their finger to a predetermined location on the touch-sensitive surface or display device, and/or by removing their finger from the touch-sensitive surface without targeting a display object.

Continuing at 350, method 300 includes selecting interactive display objects based on the offset position of the display pointer. For example, a user may manipulate the position of the display pointer to be directly over or coincident with an intended target object. In some examples, the removal of the user's finger from the touch-sensitive surface while a display object is targeted by the display pointer may result in the targeted display object being selected, activated, or engaged, in a manner similar to lifting a finger off of a depressed mouse button. In some examples, an increase in pressure between the user's finger and the touch-sensitive device may signify the user's intent to select a targeted display object (e.g., a user may press down on the touch-sensitive device while the display object is targeted by the display pointer). In such an example, removal of the user's finger may not result in the immediate removal of the display pointer from the display device. Rather, the display device may animate the vanishing of the display pointer, allowing for the user to recapture the display pointer while maintaining the offset position. If the display pointer was not targeting a display object, the user may return their finger to the touch-sensitive surface in the vicinity of the display pointer, and then manipulate the display pointer to another position on the display device. If the display pointer was targeting a display object when the user's finger was removed, subsequent return of the user's finger to the touch-sensitive surface in the vicinity of the display pointer may serve to select the targeted display object.

FIG. 5A depicts a magnified view of a user finger 501 contacting display system 15 and touch-sensitive surface 20 while display pointer 455 has been placed at an offset position, tethered to user finger 501 via indicator line 457. Display system 15 is shown presenting interactive display icons 505a-505f. Interactive display icons 505a and 505f are shown subdivided into a plurality of sub-icons 510 and 511, respectively.

In contrast with the scenario shown in FIG. 1B, the user is easily able to both visualize and select one of sub-icons 510 using display pointer 455 at the offset position. However, unless touch-sensitive surface 20 extends outside of the display screen, the offset position shown in FIG. 5A may not improve the ability of the user to visualize or select sub-icons 511, as sub-icons 511 are located in a corner of display system 15.

As described with regard to FIG. 3, a modifying command may be invoked by the user following completion of an initial phase of the triggering gesture in order to adjust a parameter of the offset position of the display pointer. FIG. 5B shows one example modifying command that may be used to adjust an orientation of the offset position relative to a finger contact patch. At 520, a finger contact patch 521 is shown with display pointer 455 having emerged (e.g., the initial phase of the triggering gesture was determined). Properties of finger contact patch 521 include boundary 522, centroid 523, first axis 524, second axis 525, upper intersection (boundary) 526, and right intersection (boundary) 527.

In this example, the modifying command entails the user continuing to roll their finger forward at an increasing approach angle, while simultaneously rolling their finger to one side. As shown at 540, subsequent finger contact patch 541 is offset to the right of finger contact patch 521. Properties of subsequent finger contact patch 541 include boundary 542, centroid 543, first axis 544, second axis 545, upper intersection (boundary) 546, and right intersection (boundary) 547. In this example, boundary 542 has a decreased area compared with boundary 522, first axis 544 is shorter than first axis 524, while second axis 545 is also shorter than second axis 525, yielding an ellipsoid shape more in proportion to initial finger contact patch 406 than intermediate finger contact patch 465 or final finger contact patch 485 shown in FIG. 4. Centroid 543 is offset from centroid 523 both along first axis 524 and second axis 525. Upper intersection 546 advances further away from centroid 523, while right intersection 547 is maintained at a relatively equal distance to centroid 523 when compared to right intersection 527.

The progression from 520 to 540 may thus represent an initial phase of a modifying command, and may be detected based on a comparison of one or more properties of successive finger contact patches, as described for the recognition of the initial phase of the triggering gesture and secondary phase/completion of the triggering gesture. Responsive to detection of the initial phase of this modifying command, display pointer 455 is offset to the right of first axis 544.

Similarly, a secondary phase of the modifying command may be detected following the initial phase, which may lead to display pointer 455 being locked to an adjusted offset position. In this example, as shown at 560, subsequent finger contact patch 561 is offset to the right of finger contact patch 541. Properties of subsequent finger contact patch 561 include boundary 562, centroid 563, first axis 564, second axis 565, upper intersection (boundary) 566, and right intersection (boundary) 567. In this example, boundary 562 has a decreased area compared with boundary 542, first axis 562 is shorter than first axis 542, and second axis 565 is also shorter than second axis 545. Centroid 563 is offset from centroid 543 both along first axis 544 and second axis 545. Upper intersection 566 advances further away from centroid 543, while right intersection 567 is maintained at a relatively equal distance to centroid 543 when compared to right intersection 547. Display pointer 455 is now locked in an adjusted offset position to the right of first axis 564.

FIG. 5C shows another example modifying command that may be used to adjust an orientation and distance of the offset position relative to a finger contact patch. A user has evoked display pointer 455 on display screen 15 with a first finger 570 of a first hand 571, while also contacting touch-sensitive surface 20 with a second finger 572 of a second hand 573, as shown at 580. In this example, contacting touch-sensitive surface 20 with a second finger is sufficient to allow the initial phase of the modifying command to be detected, while display pointer 455 is progressing towards an offset position. At 585, second user finger 472 has moved along touch-sensitive surface in a first direction, thus elongating the distance between display pointer 455 and first user finger 570. At 590, second user finger 472 has moved along touch-sensitive surface in a second direction, orthogonal to the first direction, thus adjusting the orientation of display pointer 455 to first user finger 570. In some examples, removing second user finger 472 from touch-sensitive surface 20 marks the end of the modifying command, and may thus be detected by touch-sensitive display device 10, thus locking display pointer 455 to the adjusted offset position.

Although the examples shown in FIGS. 5B and 5C show display pointer 455 remaining tethered to the upper boundary of a finger contact patch, other scenarios and modifying commands may be used to enable display pointer 455 to be tethered to a lower boundary, thus allowing a user to target display objects at the bottom edge of a display device, for example, sub-icons 511.

In some embodiments, the methods and processes described herein may be tied to a computing system of one or more computing devices. In particular, such methods and processes may be implemented as a computer-application program or service, an application-programming interface (API), a library, and/or other computer-program product.

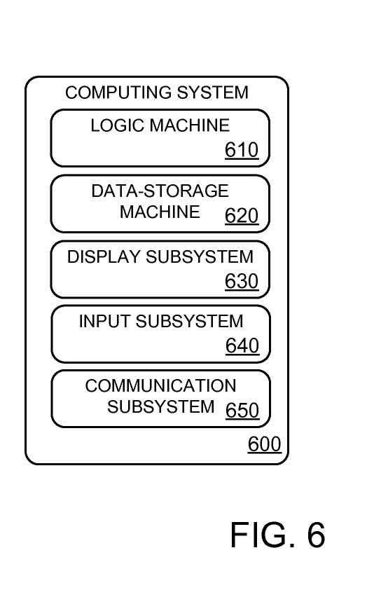

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 610 and a data-storage machine 620. Computing system 600 may optionally include a display subsystem 630, input subsystem 640, communication subsystem 650, and/or other components not shown in FIG. 6.

Logic machine 610 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Data-storage machine 620 includes one or more physical devices configured to hold instructions executable by the logic machine to implement the methods and processes described herein. When such methods and processes are implemented, the state of data-storage machine 620 may be transformed—e.g., to hold different data.

Data-storage machine 620 may include removable and/or built-in devices. Data-storage machine 620 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-storage machine 620 may include volatile, nonvolatile, dynamic, static, read/write, read-only, random-access, sequential-access, location-addressable, file-addressable, and/or content-addressable devices.

It will be appreciated that data-storage machine 620 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 610 and data-storage machine 620 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 610 executing instructions held by data-storage machine 620. For example, method 300 shown in FIG. 3 may be instantiated via logic machine 610 executing instructions held by data-storage machine 620. Logic machine 610 and storage machine 620 may receive information from components of input subsystem 640, such as touch-sensitive surface 20, and thus instructions stored on data-storage machine 620 may be executed by logic machine 610 in order to determine properties of finger contact patches and to detect triggering gestures and modifying commands, as discussed with reference to FIGS. 1B, 4, and 5A-5D.

It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 630 may be used to present a visual representation of data held by data-storage machine 620. This visual representation may take the form of a graphical user interface (GUI). As the herein described methods and processes change the data held by the storage machine, and thus transform the state of the storage machine, the state of display subsystem 630 may likewise be transformed to visually represent changes in the underlying data. Display subsystem 630 may include one or more display devices utilizing virtually any type of technology. Such display devices may be combined with logic machine 610 and/or data-storage machine 620 in a shared enclosure, or such display devices may be peripheral display devices. Display system 15 depicted in FIG. 1A is an example of a display device that may be included in display subsystem 630.

When included, input subsystem 640 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. Touch-sensitive surface 20 and user-input button 27 depicted in FIG. 1A are examples of user-input devices that may be included in input subsystem 640.

When included, communication subsystem 650 may be configured to communicatively couple computing system 600 with one or more other computing devices. Communication subsystem 650 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

In one example, a method for a touch-sensitive display device is presented, comprising determining an initial finger contact patch for a user finger contacting a touch-sensitive surface of the touch-sensitive display device, assigning a default position to a display pointer based on the initial finger contact patch, and assigning the display pointer to an offset position, different from the default position responsive to detecting a triggering gesture input from the user finger. In this example or any other example, the method may additionally or alternatively comprise determining a secondary finger contact patch for the user finger upon completion of the triggering gesture input, and assigning the offset position to the display pointer based on the secondary finger contact patch. In this example or any other example, detecting a triggering gesture input may additionally or alternatively be based on a comparison of one or more properties of the initial finger contact patch to one or more properties of the secondary finger contact patch. In this example or any other example, the comparison of one or more properties of the initial finger contact patch to one or more properties of the secondary finger contact patch may additionally or alternatively include a comparison of a position of a centroid of the secondary finger contact patch to a position of an upper boundary of the initial finger contact patch. In this example or any other example, the offset position may additionally or alternatively be outside boundaries of the secondary finger contact patch. In this example or any other example, the offset position may additionally or alternatively be maintained outside boundaries of subsequent finger contact patches following assigning the offset position to the display pointer. In this example or any other example, the offset position may additionally or alternatively be set at a predetermined distance from a centroid of the secondary finger contact patch at a predetermined orientation to the boundaries of the secondary finger contact patch. In this example or any other example, the triggering gesture may additionally or alternatively include a plurality of intermediate finger contacting patches between the initial finger contact patch and the secondary finger contact patch, and centroids of the intermediate finger contact patches may additionally or alternatively be located substantially along a long-axis of the initial finger contact patch. In this example or any other example, a distance between centroids of the intermediate finger contact patches and the centroid of the initial finger contact patch may additionally or alternatively progressively increase without decreasing. In this example or any other example, boundaries of the intermediate finger contact patches may additionally or alternatively comprise progressively diminishing areas. In this example or any other example, the method may additionally or alternatively comprise adjusting a display position of the display pointer on a display of the touch-sensitive display device from the default position towards the offset position responsive to detecting an initial phase of the triggering gesture input. In this example or any other example detecting an initial phase of the triggering gesture input may additionally or alternatively be based on a comparison of one or more properties of the initial finger contact patch to one or more properties of one or more subsequent finger contact patches. In this example or any other example, the comparison of one or more properties of the initial finger contact patch to one or more properties of one or more subsequent finger contact patches may additionally or alternatively include a comparison of a position of a centroid of the initial finger contact patch to positions of centroids of the one or more subsequent finger contact patches over time. In this example or any other example, the default position may additionally or alternatively be within boundaries of the initial finger contact patch, and the offset position may additionally or alternatively be outside the boundaries of the initial finger contact patch.

In another example, a method for a touch-sensitive display device is presented, comprising determining a centroid of an initial finger contact patch for a user finger contacting a touch-sensitive surface of the touch-sensitive display device, assigning a default position of a display pointer based on the centroid of the initial finger contact patch, detecting completion of a triggering gesture resulting in a centroid of a secondary finger contact patch being outside a boundary of the initial finger contact patch, and assigning an offset position to the display pointer based on the centroid of the secondary finger contact patch. In this example or any other example, the triggering gesture may additionally or alternatively include a plurality of intermediate finger contacting patches between the initial finger contact patch and the secondary finger contact patch, and the centroids of the intermediate finger contact patches may additionally or alternatively be located substantially along a long-axis of the initial finger contact patch. In this example or any other example, the method may additionally or alternatively comprise adjusting a display position of the display pointer from the default position towards the offset position responsive to a centroid of an intermediate finger contacting patch exceeding a threshold distance from the centroid of the initial finger contact patch along the long-axis of the initial finger contact patch.

In yet another example, a touch-sensitive display device is presented, comprising a touch-sensitive surface overlaid on a display system, and a controller to determine an initial finger contact patch for a user finger contacting a touch-sensitive surface of the touch-sensitive display device, assign a default position to a display pointer based on the initial finger contact patch, and assign the display pointer to an offset position, different from the default position responsive to receiving a triggering gesture input from the user finger. In this example or any other example, the controller may additionally or alternatively be configured to determine a secondary finger contact patch for the user finger upon completion of the triggering gesture input, and assign the offset position to the display pointer based on the secondary finger contact patch. In this example or any other example, the triggering gesture may additionally or alternatively include a plurality of intermediate finger contacting patches between the initial finger contact patch and the secondary finger contact patch, and centroids of the intermediate finger contact patches may additionally or alternatively be located substantially along a long-axis of the initial finger contact patch.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for a touch-sensitive display device, comprising:
determining an initial finger contact patch for a user finger contacting a touch-sensitive surface of the touch-sensitive display device;
assigning a default position to a display pointer based on the initial finger contact patch; and
responsive to detecting a triggering gesture input from the user finger, assigning the display pointer to an offset position, different from the default position.

2. The method of claim 1, further comprising:
determining a secondary finger contact patch for the user finger upon completion of the triggering gesture input; and
assigning the offset position to the display pointer based on the secondary finger contact patch.

3. The method of claim 2, wherein detecting a triggering gesture input is based on a comparison of one or more properties of the initial finger contact patch to one or more properties of the secondary finger contact patch.

4. The method of claim 3, wherein the comparison of one or more properties of the initial finger contact patch to one or more properties of the secondary finger contact patch includes a comparison of a position of a centroid of the secondary finger contact patch to a position of an upper boundary of the initial finger contact patch.

5. The method of claim 2, wherein the offset position is outside boundaries of the secondary finger contact patch.

6. The method of claim 5, wherein the offset position is maintained outside boundaries of subsequent finger contact patches following assigning the offset position to the display pointer.

7. The method of claim 5, wherein the offset position is set at a predetermined distance from a centroid of the secondary finger contact patch at a predetermined orientation to the boundaries of the secondary finger contact patch.

8. The method of claim 2, wherein the triggering gesture includes a plurality of intermediate finger contacting patches between the initial finger contact patch and the secondary finger contact patch, and wherein centroids of the intermediate finger contact patches are located substantially along a long-axis of the initial finger contact patch.

9. The method of claim 8, wherein a distance between centroids of the intermediate finger contact patches and the centroid of the initial finger contact patch progressively increases without decreasing.

10. The method of claim 9, wherein boundaries of the intermediate finger contact patches comprise progressively diminishing areas.

11. The method of claim 1, further comprising:
on a display of the touch-sensitive display device, adjusting a display position of the display pointer from the default position towards the offset position responsive to detecting an initial phase of the triggering gesture input.

12. The method of claim 11, wherein detecting an initial phase of the triggering gesture input is further based on a comparison of one or more properties of the initial finger contact patch to one or more properties of one or more subsequent finger contact patches.

13. The method of claim 12, wherein the comparison of one or more properties of the initial finger contact patch to one or more properties of one or more subsequent finger contact patches includes a comparison of a position of a centroid of the initial finger contact patch to positions of centroids of the one or more subsequent finger contact patches over time.

14. The method of claim 1, wherein the default position is within boundaries of the initial finger contact patch, and wherein the offset position is outside the boundaries of the initial finger contact patch.

15. A method for a touch-sensitive display device, comprising:
determining a centroid of an initial finger contact patch for a user finger contacting a touch-sensitive surface of the touch-sensitive display device;
assigning a default position of a display pointer based on the centroid of the initial finger contact patch;
detecting completion of a triggering gesture resulting in a centroid of a secondary finger contact patch being outside a boundary of the initial finger contact patch; and
assigning an offset position to the display pointer based on the centroid of the secondary finger contact patch.

16. The method of claim 15, wherein the triggering gesture includes a plurality of intermediate finger contacting patches between the initial finger contact patch and the secondary finger contact patch, and wherein centroids of the intermediate finger contact patches are located substantially along a long-axis of the initial finger contact patch.

17. The method of claim 16, further comprising:
adjusting a display position of the display pointer from the default position towards the offset position responsive to a centroid of an intermediate finger contacting patch exceeding a threshold distance from the centroid of the initial finger contact patch along the long-axis of the initial finger contact patch.

18. A touch-sensitive display device, comprising:
a touch-sensitive surface overlaid on a display system; and
a controller to:
determine an initial finger contact patch for a user finger contacting a touch-sensitive surface of the touch-sensitive display device;
assign a default position to a display pointer based on the initial finger contact patch; and
responsive to receiving a triggering gesture input from the user finger, assign the display pointer to an offset position,
different from the default position.

19. The touch-sensitive display device of claim 18, wherein the controller is further configured to:
determine a secondary finger contact patch for the user finger upon completion of the triggering gesture input; and
assign the offset position to the display pointer based on the secondary finger contact patch.

20. The touch-sensitive display device of claim 19, wherein the triggering gesture includes a plurality of intermediate finger contacting patches between the initial finger contact patch and the secondary finger contact patch, and wherein centroids of the intermediate finger contact patches are located substantially along a long-axis of the initial finger contact patch.
